(19) United States
(12) Patent Application Publication
(10) Pub. No.: US 2019/0312917 A1
(43) Pub. Date: Oct. 10, 2019

(54) RESOURCE COLLABORATION WITH CO-PRESENCE INDICATORS

(71) Applicant: Microsoft Technology Licensing, LLC, Redmond, WA (US)

(72) Inventors: Jennifer Jean CHOI, Seattle, WA (US); Jamie R. CABACCANG, Bellevue, WA (US); Kenneth Liam KIEMELE, Redmond, WA (US); Priya GANADAS, Seattle, WA (US)

(21) Appl. No.: 15/946,633

(22) Filed: Apr. 5, 2018

(51) Int. Cl. H04L 29/06; H04L 29/08

(52) U.S. Cl. CPC H04L 65/403; H04L 65/4015; H04L 67/24

(57) ABSTRACT

The herein described technology facilitates web-based co-presence collaboration conferences with user presence indicators to convey actions of users relative to a shared resource. A method for conducting a web-based co-presence collaboration conference includes selecting a form factor for a user presence indicator associated with an action of a first user identified based on data collected at one or more environmental sensors of a first co-presence collaboration device displaying the shared resource. The method further includes transmitting a presentation instruction to a second co-presence collaboration device displaying the shared resource concurrently with the first co-presence collaboration device. The presentation instruction instructs the second co-presence collaboration device to display the user presence indicator a select position relative to the shared resource and according to the selected form factor.

### BACKGROUND

Co-presence technologies provide tools that allow remotely-located individuals to collaborate and feel the sense of being present and connected with one another in a virtual environment. Web-based conferencing platforms (e.g., video conferencing) is one example co-presence technology that is gaining popularity in work environments. Additionally, there exist a variety of document sharing and collaboration platforms, such as OneDrive®, GoogleDocs®, and Dropbox®, OneNote®, that allow remotely-located individuals to jointly edit shared documents—in some cases, simultaneously. In recent years, the market has experienced some convergence between resource collaboration platforms and web-based conferencing tools as a result of efforts make virtual meetings more intimate and more collaborative. Currently, some tools exist to facilitate “whiteboard” meetings with groups of users in different physical locations, such as to allow a same electronic whiteboard or other resource to be concurrently viewed and modified by users participating in a same meeting from remote physical locations.

Even with these advances, virtual co-presence is often less comfortable than real life physical co-presence. For instance, it can be difficult for a meeting participant at one physical site to identify what other remote participants are looking at or pointing to at another physical site. In many cases, it is difficult for meeting participants to determine who is speaking and/or where the speaker is located. These shortcomings of virtual co-presence technologies leave users feeling less connected than in situations where physical co-presence can be experienced.

### SUMMARY

A method for conducting a multi-site co-presence collaboration conference includes selecting a form factor for a user presence indicator associated with a first conference participant, the form factor selected based on an action of the first user that is captured by data collected at one or more environmental sensors of a first co-presence collaboration device. The method further provides for transmitting a presentation instruction to a second co-presence collaboration device displaying a shared resource concurrently with the first co-presence collaboration device. The presentation instruction instructs the second co-presence collaboration device to display the user presence indicator at a select position relative to the shared resource and according to the selected form factor.

This Summary is provided to introduce an election of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations and implementations as further illustrated in the accompanying drawings and defined in the appended claims.

### BRIEF DESCRIPTION OF THE DRAWINGS

FIG. 1 illustrates an example co-presence collaboration system that allows collaborators at different physical meetings sites to participate in a web-based meeting while viewing and/or editing a document in a shared virtual workspace.

FIG. 2 illustrates an example co-presence collaboration system usable to facilitate a collaboration conference between participants at multiple different physical meeting sites.

FIG. 3 illustrates example operations for presenting user presence indicators in a web-based collaboration conference.

FIG. 4 illustrates an example schematic of a processing device suitable for implementing aspects of the disclosed technology.

### DETAILED DESCRIPTION

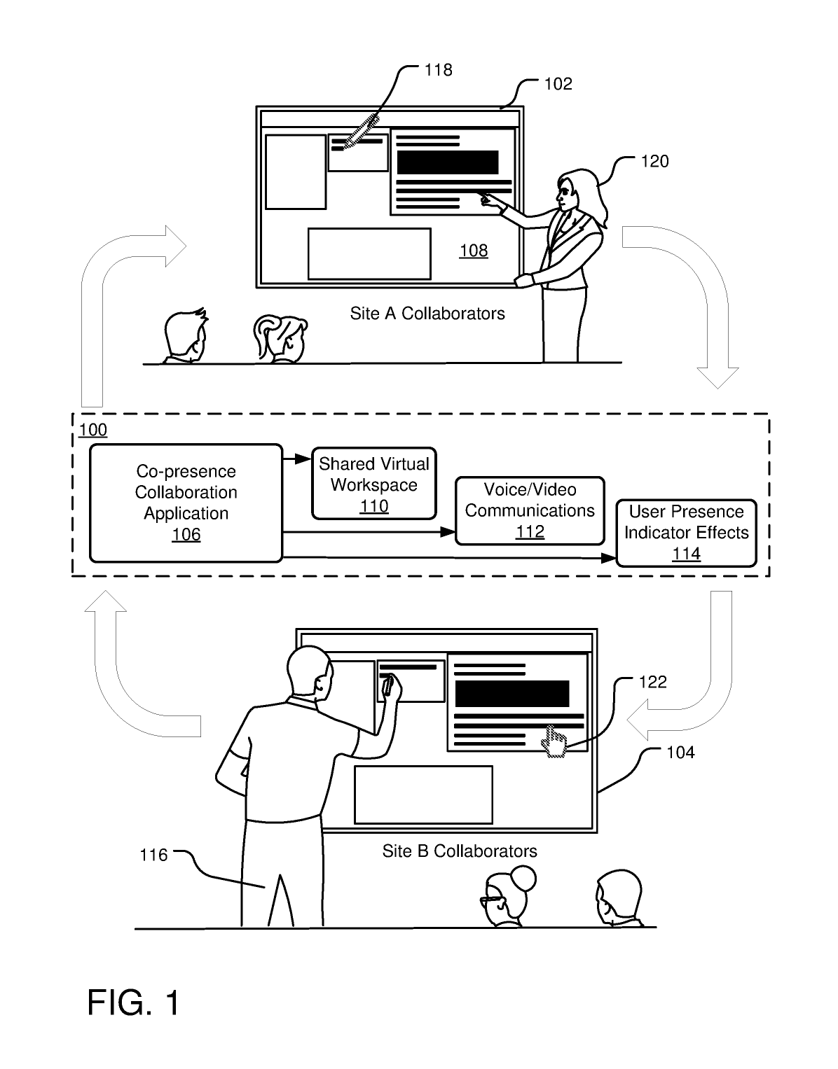

FIG. 1 illustrates an example co-presence collaboration system 100 that allows collaborators at different physical meeting sites to participate jointly in a web-based meeting while viewing and/or editing a document in a shared virtual workspace. Collaborators at a first physical site (Site A) provide input to a first co-presence collaboration device 102 while collaborators at a second physical site (Site B) provide input to a second co-presence collaboration device 104. As used herein, the term “co-presence collaboration device” refers to a processing device with capability to collect data from a surrounding environment using multiple different types of sensing (e.g., image capture, sound capture, touch input).

In FIG. 1, the co-presence collaboration devices 102, 104 are shown as large, wall-mounted touch-screen devices but may, in other implementation, take on a variety of forms including mobile devices such as phones or tablets. Each of the co-presence collaboration devices 102, 104 includes memory and one or more processors for locally executing or interacting with remotely-executed aspects a co-presence collaboration application 106. For each virtual meeting, the co-presence collaboration application 106 establishes one or more communication portals and provides a collaboration platform that allows meeting participants (also referred to herein as “collaborators”) at different physical sites (e.g., Site A, Site B) to simultaneously collaborate to create or modify a resource 108 that is presented in a shared virtual workspace 110 and presented concurrently on displays of both the co-presence collaboration devices 102, 104.

The resource 108 is, for example, a shared file that is jointly and simultaneously editable by the meeting participants at each of the physical meeting sites (Site A, Site B) logged into a same virtual meeting. In the illustrated example, the resource 108 includes a document having a multi-window layout with different windows being editable by the collaborators during the collaboration conference. In one implementation, the resource 108 is a “whiteboard” document created by the co-presence collaboration application 106 that provides functionality similar to a traditional white board, such as serving as a writing surface for a group brain-storming session. When collaborators in Site A edit the resource 108, such as by drawing (e.g., using a stylus or finger-touch), typing, or providing other input (e.g., voice input), the co-presence collaboration application 106 makes edits that are also visible to the collaborators in Site B. Likewise, the collaborators at Site B may use the co-presence collaboration application 106 to make edits that are made to the resource 108 that are also visible to the collaborators at Site A.

In one implementation, each of the co-presence collaboration devices 102, 104 locally executes an instance of the co-presence collaboration application 106 and the two instances of the co-presence collaboration application 106 communicate with one another via a local or wide-area network connection during the collaboration conference. In other implementations, the co-presence collaboration application 106 is executed in full or in-part by a server of a third-party service provider, such as a server that hosts a web-based resource sharing system that provides remote document storage and user access to online meeting portal tools. For example, various project collaborators may access the co-presence collaboration application 106 by providing certain account credentials to a website hosted by the third-party service provider that interacts with a remote server executing the co-presence collaboration application 106.

In addition to providing a shared virtual workspace 110 for collaborating on the resource 108, certain implementations of the co-presence collaboration application 106 additionally facilitate voice and/or video communications 112 between the collaborators at the different meeting sites. Additionally, the co-presence collaboration application 106 provides user presence indicator effects 114 that enhance communication intimacy between the collaborates at the different meeting sites, such as by providing graphical “indicators” that help each group of collaborators better understand the contextual scenes observable by those physically present at each meeting site.

In one implementation, the user presence indicator effects 114 include user presence indicators (e.g., icons, avatars, or other graphics) that represent locations and/or actions of individual collaborators within a room. For example, the co-presence collaboration device 102 includes one or more environmental sensors for detecting a presence (e.g., a location and/or action) of a collaborator 116 at meeting site B. The co-presence collaboration application 106 interprets data sensed from the environmental sensor(s) of the co-presence collaboration device 104 and uses such data to determine a location and form factor for a corresponding user presence indicator 118 that appears on the display of the co-presence collaboration device 102 at meeting site A. Likewise, the co-presence collaboration application 106 generates and presents another user presence indicator 122 to represent a location and/or action of another collaborator 116 at meeting site B.

In some implementations, the user presence indicator effects 114 (such as the user presence indicators 118 and 122) are displayed within the shared virtual workspace 110 and visible by users at each of the meeting sites. For example, the Site A collaborators may be able to see the user presence indicators 118, 122 for each of the collaborators 116 and 120, respectively, even though the collaborator 120 is physically present at Site A while the collaborator 116 is not physically present at Site A. In other implementations, the co-presence collaboration application 106 presents the user presence indicator for each user exclusively on the display(s) of the co-presence collaboration devices that are located at meetings site(s) remote to the collaborator associated with the user presence indicator. For example, the user presence indicator 118 may be visible to collaborators at Site B but not to those at Site A where the corresponding collaborator 120 is physically present.

Each of the user presence indicators 118 and 122 may be displayed at a virtual location (e.g., a pixel location on a display) that corresponds to a physical collaborator location relative to one of the co-presence collaboration devices 102 or 104. For example, the collaborator 116 is shown writing on the display of the co-presence collaboration device 104 and the corresponding user presence indicator 118 is presented at a select virtual location that roughly corresponds to a hand location of the collaborator 116 relative to the resource 108. As the collaborator 116 moves his hand left and right (e.g., parallel to the plane of the display of the co-presence collaborator device 104), the corresponding user presence indicator 118 moves to mirror this motion. Likewise, the illustrated example shows the collaborator 120 at Site A pointing to a location that is being discussed by the group (e.g., a “focus location”) in the resource 108, The co-presence collaboration application 106 presents the corresponding user presence indicator 122 at a corresponding virtual location such that the collaborators at Site B can identify the focus location even if they are unable to see the collaborator 120.

The user presence indicators (e.g., 118 and 122) may assume a variety of different forms including forms that vary throughout a virtual meeting based on detected actions of the corresponding collaborator. In one implementation, the co-presence collaboration application 106 selects a form factor (e.g., shape, size, appearance) for each user presence indicator based on a detected action and/or location of a user. For example, the user presence indicator may change in form based on a detected physical separation between the collaborator and the display of the associated co-presence collaboration device. In one implementation, an initial form factor is selected based on this detected separation and varied responsive to detected changes in the separation. For example, the user presence indicator 122 may grow larger and/or darker as the collaborator 120 gets closer to the display of the co-presence collaboration device 102 and then smaller and/or lighter as the collaborator 120 moves away from the display of the co-presence collaboration device 102.

In some implementations, the co-presence collaboration application 106 implements image and/or action recognition technology (e.g., gesture recognition) and selectively varies the form factor of the user presence indicator(s) based on detected actions of a corresponding collaborator. If, for example, the collaborator 116 is writing or about to start writing, the user presence indicator 118 may take on the form of a pen (as shown). If, alternatively, the collaborator 116 puts his hands at his sides while standing at the front of the room, the user presence indicator 118 may transform from that of the pen (as shown) to another form. For example, the pen may transform into another type of graphic, such as a small “person” graphic or shadow representation indicating where the collaborator 116 is currently standing. Likewise, the form factor of the co-presence indicator 118 may change responsive to other actions or gestures, such as to transform into a pointing hand icon (e.g., like the user presence indicator 122) when the co-presence collaboration application 106 detects that the user is pointing to something presented on the shared virtual workspace 110.

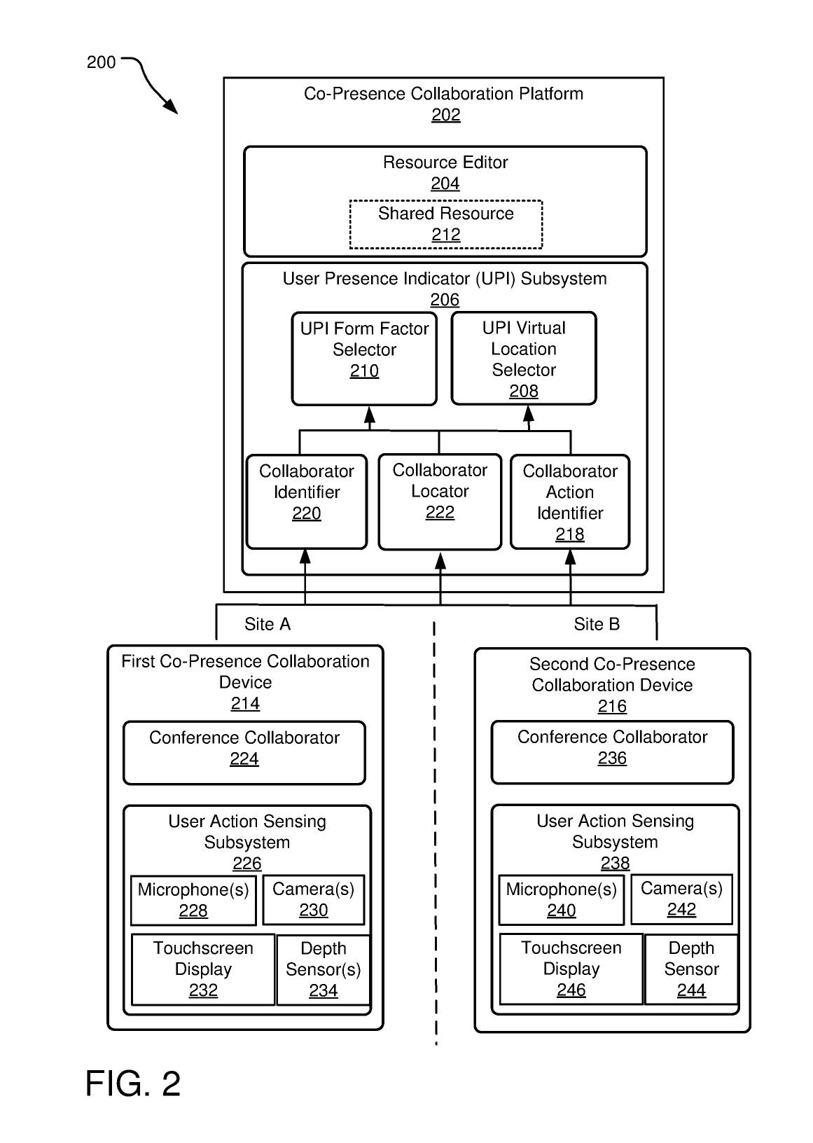

In still other implementations, the co-presence collaboration application 106 varies the form factor of each user presence indicator to indicate which collaborator is currently speaking. For example, the co-presence collaboration device 102 may include microphones that collect sound data or otherwise receive sound data from electronic accessories, such as styluses that include their own microphones and transmit data to the co-presence collaboration device 102. Using a variety of techniques, some of which are discussed with respect to FIG. 2, the co-presence collaboration application 106 may identify one of multiple recognized collaborators as a current speaker and vary the form factor of the corresponding user presence indicator to allow collaborators at the remote meeting site(s) to easily identify the current speaker.

Although the example of FIG. 1 illustrates a single user presence indicator for each of Sites A and B, some implementations of the co-presence collaboration application 106 may simultaneously display user presence indicators for more than one collaborator at each meeting site and/or for collaborator of more than two meeting sites participating in a collaboration conference. For example, the co-presence collaboration application 106 may display a user presence indicator for each of three collaborators identified as present at Site A.

In different implementations, the co-presence collaboration application 106 identifies different collaborators in a variety of ways, such as by implementing image recognition techniques to analyze camera data, one or more user-specific authentication methods (e.g., voice or facial recognition), and/or device ID recognition (e.g., such as by creating a different user presence indicator for each compatible stylus or other electronic accessory detected within a room). By using a combination of sensing technologies, the co-presence collaboration application 106 may be able to create user presence indicators that convey current locations of collaborators, actions of collaborators, and/or the identifies of collaborators. Further examples are provided below with respect to FIGS. 2-4.

FIG. 2 illustrates an example co-presence collaboration system 200 usable to facilitate a web-based collaboration conference between participants (“collaborators”) at multiple difference physical meeting sites. Although the conference may have any number of participants at any number of meeting sites, the example in FIG. 2 includes two meeting sites. A first meeting site, Site A, includes a first co-presence collaboration device 214 and a second meeting site, Site B, includes a second co-presence collaboration device 216. The first co-presence collaboration device 214 and the second co-presence collaboration device 216 each locally execute a conference collaborator 224 or 236, which communicate with a co-presence collaboration platform 202 to initiate a collaboration conference that facilitates live, multi-site editing of a shared resource 212 and exchange of voice data. In some implementations, the collaboration conference additionally facilitates the exchange of live video captured at different physical meeting sites.

Throughout the collaboration conference, the conference collaborators 224 and 236 send data to and present data received from the co-presence collaboration platform 202. In various implementations, the actions described herein as being performed by the co-presence collaboration platform 202 may be performed on one or more different processing devices, such as locally on one or both of the co-presence collaboration devices 214 and 216 or by one or more cloud-based processors, such as a third-party server hosting a web-based conferencing and resource sharing system.

In FIG. 2, the co-presence collaboration platform 202 includes a resource editor 204 that facilitates resource sharing and editing from a source location on a server (not shown), such as in the manner described above with respect to claim 1. In one implementation, the shared resource 212 is a blank “whiteboard” file that is populated with edits during the course of a co-presence collaboration conference. In another implementation, the shared resource 212 is a document created prior to the collaboration conference, such as a word file, image, or presentation slide deck that is editable during the collaboration conference, in real-time, and simultaneously at each of the first co-presence collaboration device 214 and the second co-presence collaboration device 216.

In addition to the resource editor 204, the co-presence collaboration platform 202 also includes a user presence indicator (UPI) subsystem 206 that generates and controls various user presence indicators during each conference based on an analysis of environmental data collected by sensors of the first co-presence collaboration device 214 and the second co-presence collaboration device 216. Specifically, the UPI subsystem 206 analyzes the environmental sensor data from a user action sensing subsystem 226 or 238 of each device. The user action sensing subsystems 226 and 238 include various environmental sensors for collecting data from a three-dimensional scene in proximity of the associated co-presence collaboration device. In FIG. 2, the user action sensing subsystems 226 and 238 are shown to have identical components. In other implementations, the co-presence collaboration platform 202 may facilitate collaboration conferences between devices having different user action sensing subsystems with environmental sensors different from one another and/or different from those shown in FIG. 2.

In FIG. 2, each of the user action sensing subsystems 226 and 238 includes one or more microphone(s) 228 and 240, camera(s) 230 and 242, depth sensor(s) 234 and 244, and a touchscreen display 232 and 246. During a co-presence collaboration conference, the user action sensing subsystems 226 and 238 each provide a stream of environmental sensor data to the UPI subsystem 206 of the co-presence collaboration platform 202. In turn, the UPI subsystem 206 analyzes the environmental sensor data, identifies collaborators at each of the two meeting sites based on the data, locations of each collaborator relative to the associated co-presence collaboration device 214 or 216, and actions of each user. Based on detected user locations and actions, the UPI subsystem 206 creates a user presence identifier in association with each identified user and defines dynamic attributes (e.g., location and form factor) for the user presence identifiers. Specifically, the UPI subsystem 206 includes a UPI virtual location selector 208 that selects a virtual location (e.g., a pixel location) for displaying each of the user presence indicators throughout each conference. A UPI form factor selector 210 selects the form factor (e.g., physical form such as a size, shape, color, shading, shadow) for each user presence indictor. Throughout each collaboration conference, the UPI form factor selector 210 and the UPI virtual location selector 208 may dynamically alter the form factor and/or virtual location of each one of the user presence indicators responsive to detected user actions, such as changes in user location, user gestures, and other actions (e.g., speaking v. not speaking).

In addition to the UPI form factor selector 210 and the UPU virtual location selector 208, the UPI subsystem 206 includes various other software modules (e.g., a collaborator identifier 220, a collaborator locator 222, and a collaboration action identifier 218) for analyzing the raw environmental data from the user action subsystem 226, 238 to identify the collaborators (e.g., users), collaborator locations, and collaborator actions. Of these modules, the collaborator identifier 220 is executable to process the stream of environmental sensor data and to initially identify collaborators at each physical meeting site based on the collected sensor data.

In one implementation, the collaborator identifier 220 assigns a user presence indicator (UPI) identifier to each collaborator identified at Site A and Site B. For example, the collaborator identifier 220 may analyze data of the camera(s) 230 and 242 to determine a number of faces present at each meeting site and associate a user presence indicator identifier in memory with each face. Likewise, the collaborator data collected by the depth sensor(s) 234, 244 may be usable to map a three-dimensional scene from which human shapes (bodies) can be identified. In this case, the collaborator identifier 220 may identify human shapes from the depth sensor map and assign a user presence indicator identifier to each human shape.

In still another implementation, the collaborator identifier 220 communicates with electronic accessories present at each meeting site (Site A, Site B) to identify meeting collaborators. For example, one or more users present at Site A may have on-person an accessory device, such as a stylus usable to write on the touchscreen display 232 or 246. These electronic accessories may transmit device identifiers to the collaborator identifier 220, such as using a Wi-Fi, Bluetooth, NFC, or other communication protocol. Responsive to receipt of such device identification from a source device, the collaborator identifier 220 assigns a user presence indicator identifier to the corresponding accessory device.

As each collaborator is identified by the collaborator identifier 220, a collaborator locator 222 performs operations to identify a physical location of each collaborator relative to the corresponding co-presence collaboration device (e.g., 214 or 216). For each defined user presence indicator identifier, the collaborator locator 222 identifies a physical location of the corresponding user.

In different implementations, the collaborator locator 222 may obtain location information in different ways. In one implementation, the collaborator locator 222 processes depth map data to determine coordinates of each user in a room relative to the depth sensor 234 or 244. In another implementation, the collaborator locator 222 processes proximity sensor data (e.g., such as data collected by one or more capacitive or optical sensors embedded in the touchscreen display 232 or 246) to approximate positions of nearby users as well as to detect changes in positions of users. In still another implementation, the collaborator locator 222 determines user locations by locating various device accessories, such as by obtaining micro-location inputs from one or more device accessories. For example, the collaborator locator 222 may receive micro-location from a networked configuration of receiving elements (“reference points”) that are configured to continuously monitor for signals emitted from the device accessories (e.g., styluses), detect relative strengths of the signals emitted, and determine real-time locations based on the relative signal strengths, such as by using triangulation in relation to the reference point locations.

In addition to identifying users and user locations, the UPI subsystem 206 includes another module—the collaborator action identifier 218—that performs actions for monitoring and detecting certain user actions associated with each defined user presence indicator identifier, such as actions that can be identified based on the location data gathered by the collaborator locator 222 and/or further analysis of the received environmental sensor data.

In one implementation, the collaborator action identifier 218 monitors location changes associated with each defined user presence indicator identifier. When the collaborator action identifier 218 identifies changes in user location that satisfy set criteria, such as changes both in physical separation (distance to the co-presence collaboration device 214 or 216) and/or changes in lateral alignment between a user and a display plane (e.g., a plane defined by the touchscreen display 232 or 246) of the corresponding co-presence collaborator device (214 or 216). When the collaborator action identifier 218 identifies a location change that satisfies the predetermined criteria, the collaborator action identifier 218 transmits the location changes to the UPI form factor selector 210. In turn, the UPI form factor selector 210 selectively varies the form factor of the corresponding user presence indicator based on the detected location changes. For example, the UPI form factor selector 210 may increase the size of a user presence indicator as the corresponding user moves toward the touchscreen display 232 or 246 and decrease the size of the user presence indicator as the user moves away from the touchscreen display 232 or 246.

In another implementation, the UPI form factor selector 210 alters a color or transparency of the user presence indicator responsive to detected changes in physical location between the corresponding user and co-presence collaboration device. For example, a user presence indicator may appear highly transparent when a corresponding user is far from the touchscreen display 232 or 246 but gradually less transparent as the user approaches the touchscreen display 232 or 246 to interact with the shared resource.

In another implementation, the collaborator action identifier 218 determines which, if any, of the defined user presence indicator identifiers correspond to users that are presently speaking. For example, the collaborator action identifier 218 may analyze voice data in conjunction with location data from the collaborator locator 222 to identify a most-likely source of a detected voice. In one example implementation, the co-presence collaborator device 214 includes multiple microphones 228. When voice is detected, the collaborator action identifier 218 identifies which microphone 228 detects the voice the loudest and then identifies the current speaker as being the user with an associated location that is closest to the identified microphone 228.

When the collaborator action identifier 218 identifies a current speaker (or a change in the current speaker), this information is conveyed to the UPI form factor selector 210. In turn, the UPI form factor selector 210 selects and/or modifies the form factor for a corresponding user presence indicator to reflect the “speaking” activity. For example, the UPI form factor selector 210 may graphically accentuate the user presence indicator for the current speaker, such as by presenting this indicator as a different color, shape, or size than other concurrently-presented user presence indicators. In one implementation, the UPI form factor selector 210 applies a unique animation to the user presence indicator representing the current speaker, such as by causing the associated user presence indicator to blink or rotate while the associated user is speaking. Once the user stops speaking, the associated user presence indicator may assume a prior, de-accentuated form used to denote non-speaking collaborators.

In still other implementations, the collaborator action identifier 218 utilizes image recognition techniques to recognize specific gestures or actions present in image data associated with each meeting site. For example, the collaborator action identifier 218 may use gesture identification software to determine that a user is pointing to the touchscreen display 232 or 246. If the identified gesture (“pointing”) is provided to the UPI form factor selector 210, the UPI form factor selector 210 may, in turn, selectively alter the corresponding user presence indicator to reflect this action. For example, the user presence indicator may transform into a hand pointing a finger responsive to detection of a pointing gesture. Alternatively, the user presence indicator may turn into a writing utensil (e.g., a pen) if the associated user has a hand raised and in-position to begin writing on the touchscreen display 232 or 246.

In addition to influencing the form factor of each user presence indicator, the determined user location information and user action information (e.g., identified actions) may influence the virtual location(s) at which each user presence indicator is displayed. For example, the UPI virtual location selector 208 may dynamically update the location attribute associated with each user presence indicator throughout the conference based on detected changes in user location. As a user moves left and right across meeting site A, this lateral motion may be detected by the UPI subsystem 206 and mirrored by corresponding changes in the location of the associated user presence indicator.

In some implementations, the UPI virtual location selector 208 selects a location for a user presence indicator based on an identified focal location (e.g., a focal point) within the shared resource 212. For example, the collaborator locator 222 or collaborator action identifier 218 may identify a region in the shared resource 212 that a user is gesturing toward, looking at, or otherwise engaged with. This information is provided, along with the associated user presence indicator identifier, to the UPI virtual location selector 208. The UPI virtual location selector 208 in turn updates the location attribute for the associated user presence indicator to match the identified focal location. In response, the conference collaborator 224 or 236 adjusts the location of the user presence indicator, presenting the indicator in a manner that conveys the identified focal point to meeting participants.

In one implementation the collaborator action identifier 218 analyzes depth sensor data to identify a focal location within the shared resource 212. For example, depth sensor data may be usable to identify coordinates of a user's hand in three-dimensional space relative and to extrapolate a position within the shared resource 212 that the user is pointing at.

In another implementation, the collaborator action identifier 218 analyzes the location of a user's eyes and/or pupil direction to identify a current focal location within the shared resource 212. If, for example, a user is standing very close to the touchscreen display 232 or 246, the collaborator action identifier 218 may identify the focal location as being a portion of the resource that corresponds roughly to a location of the user's eyes in a plane parallel to the touchscreen display 232. If the user's pupils are looking dramatically to one side, the collaborator action identifier 218 may determine that the focal point is not in front of the user and instead utilize a vector extrapolation method to approximate the focal location, such as by approximating a vector between the user's pupils and the plane of the touchscreen display 232 or 246.

In still other implementations, the UPI subsystem 206 uses additional information to identify a focal location for displaying an associated user presence indicator. For example, micro-location data from a device accessory may, in some cases, be usable to identify a focal point, such as when the user is pointing to a focal location with a stylus.

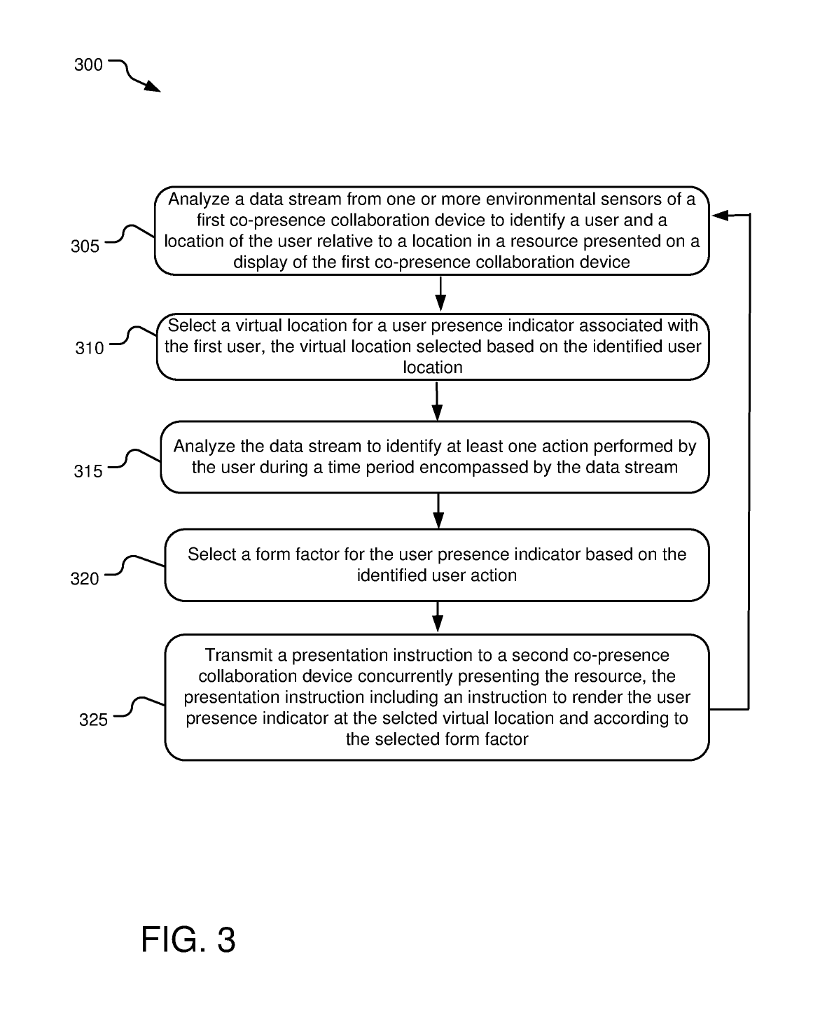

FIG. 3 illustrates example operations 300 for presenting user presence indicators in a web-based collaboration conference that includes participants from multiple physical meeting sites connected to a conference portal of a co-presence collaboration platform. During the web-based collaboration conference, a shared resource is presented concurrently on a display of each of multiple different co-presence collaboration devices at the different meeting sites participating in the collaboration conference.

A first analyzing operation 305 analyzes a data stream from one or more environmental sensors of a first co-presence collaboration device participating in the collaboration conference from a first physical meeting site. From the analysis, the analyzing operation 305 identifies a user at the first meeting site and a location of the user relative to a location in the resource that is presented on the display of the first co-presence collaboration device.

A first selection operation 310 selects a virtual location (e.g., a pixel location) for a user presence indicator that is associated with the first user. The virtual location is based on the identified user location. A second analyzing operation 315 analyzes the data stream to further identify at least one action performed by the first user during a time period encompassed by the data stream. For example, the identified user action may be a change in user location, a gesture, or a speaking action.

A second selection operation 320 selects a form factor for the user presence indicator based on the identified user action, and a transmission operation 325 transmits a presentation instruction to a second co-presence collaboration device in the collaboration conference. The presentation instruction instructs the second co-presence collaboration device to render the user presence indicator at the selected virtual location (e.g., relative to the shared resource) and according to the selected form factor.

The operations 305-325 are repeated throughout the collaboration conference to analyze new and different segments of the data stream from the environmental sensors. The form and/or virtual location of the user presence indicator may be updated throughout the conference to reflected changes in user location and new user actions. Changes to the form and/or virtual location of the user presence indicator may be included in updates to the presentation instruction that transmitted and implemented by the receiving device(s) in real-time.

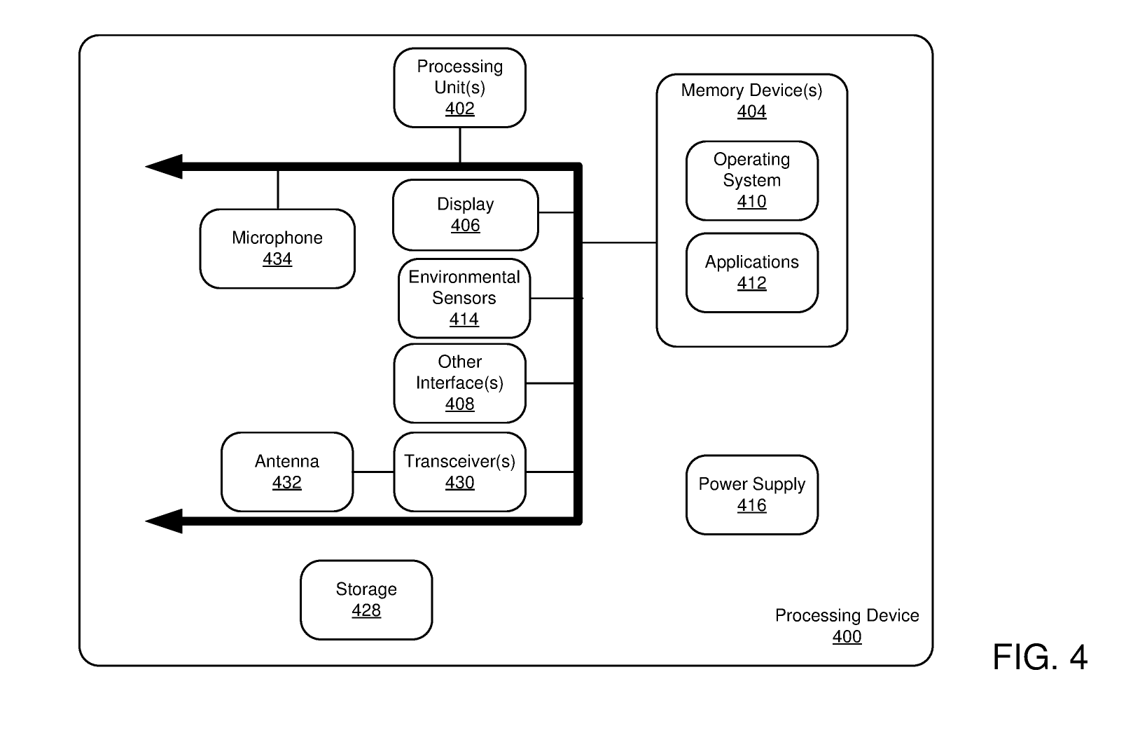

FIG. 4 illustrates an example schematic of a processing device 400 suitable for implementing aspects of the disclosed technology. In one implementation, the processing device 400 is a co-presence collaboration device. The processing device 400 includes one or more processing unit(s) 402, one or more memory devices 404, a display 406, which may be a touchscreen display, and other interfaces 408 (e.g., buttons). The processing device 400 additionally includes environmental sensors 414, which may include a variety of sensors including without limitation sensors such as depth sensors (e.g., lidar, RGB, radar sensors), cameras, touchscreens, and infrared sensors. The memory devices 404 generally includes both volatile memory (e.g., RAM) and non-volatile memory (e.g., flash memory). An operating system 410, such as the Microsoft Windows® operating system, the Microsoft Windows® Phone operating system or a specific operating system designed for a gaming device, resides in the memory devices 404 and is executed by the processing unit(s) 502, although other operating systems may be employed.

One or more applications 412, such as a co-presence collaboration application 106 of FIG. 1 or the various modules of the co-presence collaboration platform 202 of FIG. 2, are loaded in the memory device(s) 404 and are executed on the operating system 410 by the processing unit(s) 402. The processing device 400 includes a power supply 416, which is powered by one or more batteries or other power sources and which provides power to other components of the processing device 400. The power supply 416 may also be connected to an external power source that overrides or recharges the built-in batteries or other power sources.

The processing device 400 includes one or more communication transceivers 430 and an antenna 432 to provide network connectivity (e.g., a mobile phone network, Wi-Fi®, BlueTooth®). The processing device 400 may also include various other components, such as a positioning system (e.g., a global positioning satellite transceiver), one or more accelerometers, one or more cameras, an audio interface (e.g., a microphone 434, an audio amplifier and speaker and/or audio jack), and storage devices 428. Other configurations may also be employed. In an example implementation, various applications are embodied by instructions stored in memory device(s) 404 and/or storage devices 428 and processed by the processing unit(s) 402. The memory device(s) 404 may include memory of host device or of an accessory that couples to a host.

The processing device 400 may include a variety of tangible computer-readable storage media and intangible computer-readable communication signals. Tangible computer-readable storage can be embodied by any available media that can be accessed by the processing device 400 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing device 400. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example method for conducting a multi-site co-presence collaboration conference includes selecting a form factor for a user presence indicator associated with a first user, where the selected form factor is based on an action captured by data collected at one or more environmental sensors of a first co-presence collaboration device displaying a shared resource. The method further includes transmitting a presentation instruction to a second co-presence collaboration device displaying the shared resource concurrently with the first co-presence collaboration device, the presentation instruction instructing the second co-presence collaboration device to display the user presence indicator at a select position relative to the shared resource and according to the selected form factor.

In another example method of any preceding method, the method further includes detecting a change in physical separation between the first user and a display of the first co-presence collaboration device and selecting the form factor for the user presence indicator responsive based on the detected change in physical separation.

In another example method of any preceding method, the method further includes determining a location of the first user relative to a display of the first co-presence collaboration device and selecting the form factor for the user presence indicator based on the determined location of the first user.

In still another example method of any preceding method, the method further includes selecting the form factor for the user presence indicator responsive to a determination that the first user is speaking.

In still another example method of any preceding method, the method further includes selecting a virtual location to display the user presence indicator based on a physical location of the first user relative to a display of the second co-presence collaboration device.

In another example method of any preceding method, the virtual location corresponds to a focus location of the first user, the focus location being a location within the shared resource.

In yet another example method of any preceding method, the method further includes selecting a form factor for at least one other user presence indicator associated with an action of a second user, the action being captured by data collected at one or more environmental sensors of the second co-presence collaboration device displaying the shared resource. The method further includes transmitting a presentation instruction to the first co-presence collaboration device that instructs the first co-presence collaboration device to display the at least one other presence indicator according to the selected form factor associated with the action of the second user.

An example system for conducting a multi-site co-presence collaboration conference includes a means for selecting a form factor for a user presence indicator associated with a first user, where the selected form factor is based on an action captured by data collected at one or more environmental sensors of a first co-presence collaboration device displaying a shared resource. The system further includes a means for transmitting a presentation instruction to a second co-presence collaboration device displaying the shared resource concurrently with the first co-presence collaboration device, the presentation instruction instructing the second co-presence collaboration device to display the user presence indicator at a select position relative to the shared resource and according to the selected form factor.

An example co-presence collaboration system for conducting a multi-site co-presence collaboration conference includes a server hosting a shared resource; and a user presence indicator subsystem including a hardware processing unit configured to select a form factor for a user presence indicator associated with a first user, the selected form factor being based on an action captured by data collected at one or more environmental sensors of a first co-presence collaboration device displaying the shared resource. The hardware processing unit is further configured to transmit a presentation instruction to a second co-presence collaboration device displaying the shared resource concurrently with the first co-presence collaboration device to instruct the second co-presence collaboration device to display the user presence indicator at a select position relative to the shared resource and according to the selected form factor.

In another example system according to any preceding system, the user presence indicator subsystem is further configured to select the form factor for the user presence indicator responsive to a detected change in physical separation between the first user and a display of the first co-presence collaboration device.

In still another example system according to any preceding system, the user presence indicator subsystem is further configured to select the form factor for the user presence indicator based on a determined location of the first user relative to a display of the first co-presence collaboration device.

In yet another example system according to any preceding system, the user presence indicator subsystem is further configured to select the form factor for the user presence indicator responsive to a determination that the first user is speaking.

In still another example system according to any preceding system, the user presence indicator subsystem is further configured to select a virtual location to display the user presence indicator based on a physical location of the first user relative to a display of the second co-presence collaboration device.

In yet another example system according to any preceding system, the virtual location corresponds to a focus location of the first user, the focus location being a location within the shared resource.

In another example system according to any preceding system, the user presence indicator subsystem is further configured to select a form factor for at least one other user presence indicator associated with an action of a second user, where the action is captured by data collected at one or more environmental sensors of the second co-presence collaboration device displaying the shared resource. The user presence indicator subsystem is further configured to transmit a presentation instruction to the first co-presence collaboration device to instruct the first co-presence collaboration device to display the at least one other presence indicator according to the selected form factor associated with the action of the second user.

An example co-presence collaboration device for participating in a multi-site co-presence collaboration conference includes a conference collaborator stored in the memory and executable to initiate a web-based co-presence collaboration conference with a remotely-located co-presence collaboration device. The conference collaborator is further configured to access and present a shared resource that is concurrently presented by the remotely-located co-presence collaboration device, and is also configured to present a user presence indicator concurrently with the shared resource. The user presence indicator has a form factor corresponding to an action of a first user that is identified based on data collected at one or more environmental sensors of the remotely-located co-presence collaboration device.

In another example system of any preceding system, the form factor of the user presence indicator corresponds to a detected change in physical separation between the first user and a display of the remotely-located co-presence collaboration device.

In another example system of any preceding system, the form factor of the user presence indicator corresponds to a determined location of the first user relative to a display of the remotely-located co-presence collaboration device.

In still another example system of any preceding system, the form factor the user presence indicator indicates whether the first user is speaking.

In still another example system of any preceding system, the user presence indicator subsystem selects the form factor for the user presence indicator responsive to a determination that the first user is speaking.

In still yet another example system of any preceding system, the conference collaborator is further configured to present the user presence indicator at a virtual location corresponding to a physical location of the first user.

In yet another example system of any preceding system, the virtual location corresponds to a focus location of the first user, the focus location being a location within the shared resource.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method for conducting a multi-site co-presence collaboration conference, the method comprising:
selecting a form factor for a user presence indicator associated with a first user, the selected form factor based on an action captured by data collected at one or more environmental sensors of a first co-presence collaboration device displaying a shared resource; and
transmitting a presentation instruction to a second co-presence collaboration device displaying the shared resource concurrently with the first co-presence collaboration device, the presentation instruction instructing the second co-presence collaboration device to display the user presence indicator at a select position relative to the shared resource and according to the selected form factor.

2. The method of claim 1, further comprising:
detecting a change in physical separation between the first user and a display of the first co-presence collaboration device; and
selecting the form factor for the user presence indicator responsive based on the detected change in physical separation.

3. The method of claim 1, further comprising:
determining a location of the first user relative to a display of the first co-presence collaboration device; and
selecting the form factor for the user presence indicator based on the determined location of the first user.

4. The method of claim 1, further comprising:
selecting the form factor for the user presence indicator responsive to a determination that the first user is speaking.

5. The method of claim 1, further comprising:
selecting a virtual location to display the user presence indicator based on a physical location of the first user relative to a display of the second co-presence collaboration device.

6. The method of claim 5, wherein the virtual location corresponds to a focus location of the first user, the focus location being a location within the shared resource.

7. The method of claim 1, further comprising:
selecting a form factor for at least one other user presence indicator associated with an action of a second user, the action captured by data collected at one or more environmental sensors of the second co-presence collaboration device displaying the shared resource; and
transmitting a presentation instruction to the first co-presence collaboration device, the presentation instruction instructing the first co-presence collaboration device to display the at least one other presence indicator according to the selected form factor associated with the action of the second user.

8. A co-presence collaboration system for conducting a multi-site co-presence collaboration conference, the co-presence collaboration system comprising:
a server hosting a shared resource; and
a user presence indicator subsystem including a hardware processing unit configured to:
select a form factor for a user presence indicator associated with a first user, the selected form factor based on an action captured by data collected at one or more environmental sensors of a first co-presence collaboration device displaying the shared resource; and
transmit a presentation instruction to a second co-presence collaboration device displaying the shared resource concurrently with the first co-presence collaboration device, the presentation instruction instructing the second co-presence collaboration device to display the user presence indicator at a select position relative to the shared resource and according to the selected form factor.

9. The co-presence collaboration system of claim 8, wherein the user presence indicator subsystem is further configured to:
select the form factor for the user presence indicator responsive to a detected change in physical separation between the first user and a display of the first co-presence collaboration device.

10. The co-presence collaboration system of claim 8, wherein the user presence indicator subsystem is further configured to:
select the form factor for the user presence indicator based on a determined location of the first user relative to a display of the first co-presence collaboration device.

11. The co-presence collaboration system of claim 8, wherein the user presence indicator subsystem is further configured to:
select the form factor for the user presence indicator responsive to a determination that the first user is speaking.

12. The co-presence collaboration system of claim 8, wherein the user presence indicator subsystem is further configured to:
select a virtual location to display the user presence indicator based on a physical location of the first user relative to a display of the second co-presence collaboration device.

13. The co-presence collaboration system of claim 12, wherein the virtual location corresponds to a focus location of the first user, the focus location being a location within the shared resource.

14. The co-presence collaboration system of claim 8, wherein the user presence indicator subsystem is further configured to:
select a form factor for at least one other user presence indicator associated with an action of a second user, the action captured by data collected at one or more environmental sensors of the second co-presence collaboration device displaying the shared resource; and
transmit a presentation instruction to the first co-presence collaboration device, the presentation instruction instructing the first co-presence collaboration device to display the at least one other presence indicator according to the selected form factor associated with the action of the second user.

15. A co-presence collaboration device for participating in a multi-site co-presence collaboration conference, the co-presence collaboration device comprising:
memory;
a processor;
a conference collaborator stored in the memory and executable by the processor to:
initiate a web-based co-presence collaboration conference with a remotely-located co-presence collaboration device;
access and present a shared resource, the shared resource being concurrently presented by the remotely-located co-presence collaboration device;
present a user presence indicator concurrently with the shared resource, the user presence indicator having a form factor corresponding to an action of a first user, the action identified based on data collected at one or more environmental sensors of the remotely-located co-presence collaboration device.

16. The co-presence collaborator device of claim 15, wherein the form factor corresponds to a detected change in physical separation between the first user and a display of the remotely-located co-presence collaboration device.

17. The co-presence collaborator device of claim 15, wherein the form factor corresponds to a determined location of the first user relative to a display of the remotely-located co-presence collaboration device.

18. The co-presence collaborator device of claim 15, wherein the form factor indicates whether the first user is speaking.
select the form factor for the user presence indicator responsive to a determination that the first user is speaking.

19. The co-presence collaborator device of claim 15, wherein the conference collaborator is further configured to present the user presence indicator at a virtual location corresponding to a physical location of the first user.

20. The co-presence collaborator device of claim 19, wherein the virtual location corresponds to a focus location of the first user, the focus location being a location within the shared resource.
